(19) United States
(12) Patent Application Publication
(10) Pub. No.: US 2021/0183400 A1
(43) Pub. Date: Jun. 17, 2021

(54) AUDITORY STYLUS SYSTEM

(71) Applicant: Mayo Foundation for Medical Education and Research, Rochester, MN (US)

(72) Inventors: Michael J. Cevette, Cave Creek, AZ (US); Jan Stepanek, Scottsdale, AZ (US); Gaurav N. Pradhan, Fountain Hills, AZ (US); Jamie M. Bogle, Scottsdale, AZ (US); Sarah O. Holbert, Phoenix, AZ (US); David P. Upjohn, Scottsdale, AZ (US)

(21) Appl. No.: 17/118,029

(22) Filed: Dec. 10, 2020

Related U.S. Application Data
(60) Provisional application No. 62/946,708, filed on Dec. 11, 2019.

(51) Int. Cl. G10L 21/02; G10L 15/22; G10L 15/183; G06F 3/16; H04R 1/02; H04R 1/04; H04R 1/10; G06F 3/0354

(52) U.S. Cl. CPC G10L 21/02; G10L 15/22; G10L 15/183; G06F 3/167; H02J 7/0045; H04R 1/04; H04R 1/1016; G06F 3/03545; H04R 2420/07; H04R 1/025

(57) ABSTRACT

A speech enhancement system including an auditory stylus and optionally one or both of an earpiece and communication device. The auditory stylus, by itself and/or in cooperation with one or both of earpiece or communication device, provide users with multiple operating mode functions that can enhance the users' ability to understand speech and other sound. Embodiments may operate in one or more of an original speech mode, filtered speech mode, transcription mode or translation mode.

### CROSS-REFERENCE TO RELATED APPLICATION

This application claims the benefit of U.S. Provisional Application No. 62/946,708, filed Dec. 11, 2019, which is incorporated herein by reference in its entirety for all purposes.

### FIELD

The disclosure relates generally to devices and systems for enhancing speech understanding or perception. Embodiments include a hand held auditory stylus that can used to enhance the perception of speech.

### BACKGROUND

There remains a continuing need for devices, systems and methods that enhance the ability of individuals to understand or perceive speech that they hear. Such a system that is convenient to use as well as effective would be especially desirable.

### SUMMARY

Disclosed embodiments include a handheld auditory stylus. Embodiments of the stylus may comprise: a housing configured to be held, supported and/or moved by a user's hand; an operator interface coupled to the housing (optionally for selecting an operating mode); a built-in speaker coupled to the housing; a built-in microphone coupled to the housing; a remote microphone including a wireless transmitter (optionally Bluetooth) configured to be removably attached to the housing; a wireless transceiver (optionally Bluetooth and/or WiFi) coupled to the housing and configured to wirelessly receive speech from the remote microphone (and optionally communicate information with other wireless transceivers); a memory component coupled to the housing; a speech filter component coupled to the housing and configured to enhance speech intelligibility; and an interface/control component coupled to the housing, operator interface, built-in speaker, built-in microphone, wireless transceiver, memory and speech filter. The interface/control component may be configured to: cause speech received by the built-in microphone and from the remote microphone via the wireless transceiver to be filtered by the speech filter component (optionally, for example, during operation in a filtering mode); cause the filtered speech to be stored in the memory (optionally, for example, during operation in a storage mode); cause the filtered speech to be broadcast by the built-in speaker (e.g. in real time and/or in delayed time via the memory) (optionally, for example, during operation in a broadcast mode); and cause the filtered speech to be transmitted by the wireless transceiver (e.g., in real time and/or in delayed time via the memory) (optionally, for example, during operation in a transmit mode).

Embodiments may further include a transcription component coupled to the housing and the interface/control component. In such embodiments, the interface/component may be configured to: cause the speech received from the built-in microphone and/or from the remote microphone to be transcribed by the transcription component (optionally, for example, during operation in a transcribe mode); cause the transcribed speech to be stored in the memory (optionally, for example, during operation in a transcribed speech storage mode); and cause the transcribed speech to be transmitted by the wireless transceiver (e.g., in real time and/or in delayed time from the memory) (optionally, for example, during operation in a transcribed speech transmit mode).

Any or all of the above embodiments may further include a translation component coupled to the housing and the interface/control component. In such embodiments the interface/component may be configured to: cause the speech received from the built-in microphone and/or from the remote microphone to be translated (optionally, for example, during operation in a translate mode); cause the translated speech to be stored in the memory (optionally, for example, during operation in a translated speech storage mode); cause the translated speech to be broadcast by the built-in speaker (e.g., in real time and/or in delayed time via the memory) (optionally, for example, during operation in a translated speech broadcast mode); and cause the translated speech to be transmitted by the wireless transceiver (e.g., in real time and/or in delayed time from the memory) (optionally, for example, during operation in a translated speech transmit mode).

In any or all of the above embodiments the operator interface may be operable to control operation of the stylus, optionally including to select one or more operating modes (optionally, for example, one or more of a filtering mode, filtered speech storage mode, filtered speech broadcast mode, filtered speech transmit mode, transcribe mode, transcribed speech storage mode, transcribed speech transmit mode, translate mode, translated speech storage mode, translated speech broadcast mode and/or translated speech transmit mode).

Any or all of the above embodiments may further comprise a communication device, (optionally a tablet, mobile phone and/or laptop computer). In such embodiments the communication device may include: a user interface; a display; memory; a wireless receiver (optionally Bluetooth and/or WiFi) for receiving from the handheld stylus one or more of the transmitted filtered speech, transcribed speech and/or translated speech; a speaker; and a control component coupled to the user interface, display, memory, wireless receiver and speaker. In such embodiments the control component may be configured to: cause the received one or more of the transmitted filtered speech, transcribed speech and/or translated speech to be stored in the memory (optionally, for example, during a received speech storage mode); cause the received one of more of the transmitted filtered speech, transcribed speech and/or translated speech to be broadcast by the speaker (e.g. in real time and/or in delayed time via the memory) (optionally, for example, during a received speech broadcast mode); and cause the received one or more of the transmitted filtered speech, transcribed speech and/or translated speech to be displayed in text form by the display (e.g. in real time and/or in delayed time via the memory) (optionally, for example, during a received speech display mode).

In any or all of the above embodiments the communication device may further include a transcription component coupled to the control component (e.g., in embodiments where the handheld auditory stylus does not include a transcription component). In such embodiments the control component may be configured to: cause the speech received from handheld auditory stylus to be transcribed (optionally, for example, during a communication device transcribe mode); cause the transcribed speech to be stored in the memory (optionally, for example, during a communication device transcribed speech storage mode); cause the transcribed speech to be displayed in text form by the display (e.g., in real time and/or in delayed time from the memory) (optionally, for example, during a communication device transcribed speech display mode); and cause the transcribed speech to be broadcast (e.g., in real time and/or in delayed time from the memory) (optionally, for example, during a communication device transcribed speech broadcast mode).

In any or all of the above embodiments the communication device may further include a translation component coupled to the control component (e.g., in embodiments where the handheld auditory stylus does not include a translation component). The control component in such embodiments may be configured to: cause the speech received from handheld auditory stylus to be translated (optionally, for example, during a communication device translate mode); cause the translated speech to be stored in the memory (optionally, for example, during a communication device translated speech storage mode); cause the translated speech to be displayed in text form by the display (e.g., in real time and/or in delayed time from the memory) (optionally, for example, during a communication device translated speech display mode); and cause the translated speech to be broadcast (e.g., in real time and/or in delayed time from the memory) (optionally, for example, during a communication device translated speech transmit mode).

In any or all of the above embodiments the user interface of the communication device may be operable to control operation of the communication device, optionally including to select one or more operating modes (optionally, for example, one or more of a received speech storage mode, a received speech display mode, a received speech broadcast mode, a communication device transcribed speech storage mode, a communication device transcribed speech display mode, a communication device translated speech storage mode, a communication device translated speech display mode, and a communication device translated speech broadcast mode.

Any or all of the above embodiments may further include one or more earpiece. In such embodiments each earpiece may comprise: an ear mount configured to support the earpiece on a user's ear; a wireless receiver (optionally Bluetooth) coupled to the ear mount for receiving from the handheld stylus one or more of the transmitted filtered speech, and/or translated speech (e.g., during operation of the stylus during the transmit mode); and a speaker coupled to the receiver to broadcast the received one or more of the filtered speech and/or translated speech.

In any or all of the above embodiments the stylus may further comprise a writing instrument (optionally an ink pen or instrument for operating the user interface of the communication device).

In any or all of the above embodiments the housing of the stylus may comprise an elongated structure including a hand-engaging portion having a generally circular cross section.

Any or all of the above embodiments may further include a cap configured to be removably coupled to the stylus. In embodiments, the cap includes a battery and is configured for coupling to the auditory stylus in a power transfer configuration. In embodiments, the cap includes a rechargeable battery and is configured for coupling to the auditory stylus in a storage configuration at which the rechargeable battery can be connected to a battery charger. In embodiments, the cap is configured to be removably coupled to an end of the auditory stylus including the writing instrument when in the storage configuration. In embodiments, the cap is configured to be removably coupled to an end of the auditory stylus opposite the end with the writing instrument when in the power transfer configuration.

### BRIEF DESCRIPTION OF THE DRAWINGS

FIG. 1 is a diagrammatic illustration of components of a speech enhancement system, in accordance with embodiments.

FIG. 2 is a diagrammatic illustration of components of an auditory stylus, in accordance with embodiments.

FIG. 3 illustrates a graph of gain vs. frequency that may be provided by a speech filter component of the auditory stylus, in accordance with embodiments.

FIG. 4 is a diagrammatic illustration of components of a communication device, in accordance with embodiments.

FIG. 5 is a diagrammatic illustration of an earpiece, in accordance with embodiments.

FIGS. 6A and 6B are diagrammatic illustrations of an auditory stylus, in accordance with embodiments.

FIG. 7 is a diagrammatic illustration of a cap for an auditory stylus, in accordance with embodiments.

### DETAILED DESCRIPTION

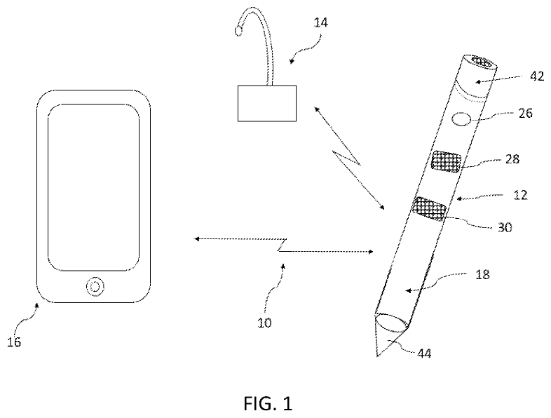

FIG. 1 illustrates a speech enhancement system 10 including an auditory stylus 12, earpiece 14 and communication device 16 in accordance with embodiments. As described in greater detail below, auditory stylus 12, by itself and/or in cooperation with one or both of earpiece 14 or communication device 16, provide users with multiple operating mode functions that can enhance the users' ability understand speech and other sound (i.e., to perceive the speech).

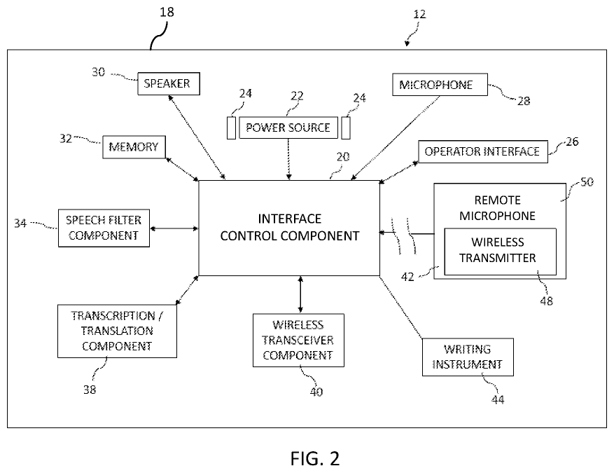

FIG. 2 is a diagrammatic illustration of embodiments of the auditory stylus 12. With reference to FIGS. 1 and 2, auditory stylus 12 includes components coupled to or mounted within a housing 18. Illustrated components include interface/control component 20 which can be coupled to a power source 22 such as a rechargeable battery through contacts 24, operator interface 26, microphone 28, speaker 30, memory 32, speech filter component 34, transcription/translation component 38 and wireless transceiver component 40. A remote microphone 42 is removably attached to the housing 18. Embodiments may include a writing instrument 44 on the housing 18 (e.g., on an end portion of the housing). In the embodiments illustrated in FIG. 1, the auditory stylus 12 is configured as a handheld device. In these and other embodiments the housing 14 is elongated and generally circular in cross section with a hand-engaging portion, such as conventional writing instruments. The user can thereby hold, manipulate and position the auditory stylus 12 using their hand.

Microphone 28 is a built-in device in the illustrated embodiments. Ambient sound, including speech, received by microphone 28, is converted to electrical signals (i.e., speech signals) for processing and use as described herein. Speech filter component 34, for example, enhances the intelligibility of the speech received by the microphone 28 by selectively amplifying the spectral or frequency content of the speech. Data or information representative of the speech received by microphone 28 (i.e., the original or received speech), and/or data representative of the filtered speech can be stored in the memory 32. Electrical signals representative of the filtered speech and/or the original speech can be converted to audible form and broadcast by the speaker 30.

The illustrated embodiments of auditory stylus 12 include transcription/translation component 38 to provide transcription and/or translation functionality. By the transcription functionality, the transcription/translation component 38 transcribes the speech (e.g., the original speech and/or the filtered speech) into text-based form. By the translation functionality, the transcription/translation component 38 translates the speech (e.g., the original speech and/or the filtered speech and/or the transcribed speech) into different languages. For example, the transcription/translation component 38 can translate the speech from English to Spanish. Translated speech provided by the transcription/translation component 38 can be transcribed by the transcription/translation component 38. Transcription/translation component 38 can include conventional or otherwise know transcription and/or translation software. Transcribed speech and/or translated speech provided by the transcription/translation component 38 can be stored in the memory 32 and/or broadcast by the speaker 30. As described below, other embodiments of auditory stylus 12 do not include transcription/translation component 38.

Wireless transceiver component 40 is configured to wirelessly transmit information from the auditory stylus 12 and to wirelessly receive information by the stylus. In embodiments, the wireless transceiver component 40 transmits information to and/or receives information from the communication component 16. In embodiments the wireless transceiver component 40 transmits information to the one or more earpieces 14. For example, and as described in greater detail below, the wireless transceiver component 40 can transmit and/or receive the original speech, filtered speech, transcribed speech and/or translated speech. Wireless transceiver component 40 comprises a relatively short-range transceiver in embodiments (e.g., Bluetooth technology). Alternatively or in addition, wireless transceiver component 40 comprises a relatively long-range transceiver in embodiments (e.g., WiFi technology). Wireless transceiver component 40 may comprise conventional or otherwise known wireless technologies.

Remote microphone 42 includes a microphone and wireless transmitter 48 mounted to a housing 50. Remote microphone 42 is configured to be removably attached to the auditory stylus 12 in embodiments. In embodiments, the remote microphone 42 can be removably attached to the housing 18 of the auditory stylus 12. Magnets, resilient clips, snaps, hook and loop fasteners and buckles on the housing 50 of the microphone 42 and/or the housing 18 of the stylus 12 are non-limiting examples of types of structures that can be used to releasably attach the remote microphone to the auditory stylus. Ambient sound, including speech, received by the remote microphone 42 is converted to electrical signals (i.e., speech signals). Wireless transmitter 48 is configured for data communications with wireless transceiver component 40, and transmits remotely received speech to the wireless transceiver component. The wireless transmitter 48 of the remote microphone 42 can, for example, be a short-range transmitter such as a Bluetooth device. As described in greater detail below, the remote microphone 42 is thereby configured to be detached from the housing 18, located remotely at a distance spaced from the auditory stylus 12, and to transmit speech (i.e., remote speech) to the auditory stylus 12 for processing (e.g., in a manner similar to or substantially the same as that of the speech received by the built-in microphone 28). In embodiments, remote microphone 28 can be configured to provide the functionality described herein, but is not configured to be removably attached to the housing 18. Remote microphone 42 may be powered by a battery (not shown), such as for example a rechargeable battery.

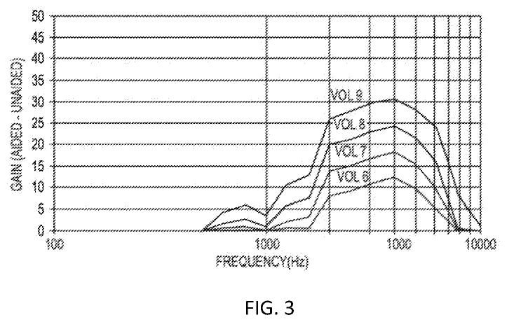

Speech filter component 34, as noted above, enhances the intelligibility of speech received by the microphone 28 and/or the remote microphone 42. In embodiments, the speech filter component 34 selectively amplifies spectral components of the speech signal that are most relevant to speech intelligibility. FIG. 3 illustrates a graph of gain vs. frequency that may be provided by speech filter component 34. In embodiments, the amplified frequency range can have a lower end between about 800 Hz and 1,700 Hz, and an upper end between about 7,000 Hz and 11,000 Hz. In other embodiments the lower end of the amplified frequency range is between about 1,000 Hz and 1,500 Hz, and the upper end of the amplified frequency range is about 8,000 and 10,000 Hz. The amount of amplification of the speech signals at the lower end of the amplified frequency range can be about 5 dB or less (e.g., down to about 0 dB). Similarly, the amount of amplification of the speech signals at the upper end of the amplified range can be about 5 dB or less (e.g., down to about 0 dB). In the embodiments shown in FIG. 3, the gain generally increases from the value at the lower end of the amplified range to a maximum value at frequencies between about 3,000 Hz and 4,500 Hz, and generally decreases from the maximum value to the value at the upper end of the amplified range. The maximum amplification value can, for example, be between about 10 dB and 30 dB. As is also shown in FIG. 3, the amount of amplification can be selected by the user, for example through the use of the operator interface 26.

The amplification frequency thresholds (i.e., the frequencies at which the amplification begins and/or ends), and the amplification transfer function of the speech filter component 34 can vary in different embodiments. In general, speech filter component 34 is configured to amplify sound having frequencies above the range of significant portions of ambient noise in the sound. For example, the amplification threshold frequency and/or transfer function can be configured for use and selection of different situation applications such as for example use in an airplane and use in an outdoor street setting. In general, the speech intelligibility index (SII) assumes that speech recognition increases in direct proportion to speech spectrum audibility, which can be calculated from the hearing thresholds of the listener, and the long term average spectra of the speech and noise reaching the ear of the listener. SII=ΣIᵢAᵢ where Iᵢ is the function that characterizes the importance of the ith frequency band to speech intelligibility, and Aᵢ expresses the proportion of the speech dynamic range in the ith frequency band that is above the listener's threshold or masking noise. Noise and other relatively low-frequency components of the sound signals that typically do not contain information important to the intelligibility of the speech, and that can detract from the ability of the hearing impaired to derive useful information from the sound, are effectively filtered out. Embodiments of speech filter component 34 therefore do not add proportional perceived noise into the environment, while enhancing the volume of the information-containing content of the sound spectrum. Reverberations from room acoustics can also be significantly reduced by system 10, another factor contributing to the enhanced speech intelligibility provided by the system.

Writing instrument 44 can be configured to provide one or more different functions. In embodiments, for example, the writing instrument 44 is a conventional pen or pencil to physically transfer ink or otherwise create markings. In embodiments such as these the auditory stylus 12 can function as a conventional writing instrument. In embodiments the writing instrument 44 is configured to interface with and operate the communication device 16 (e.g., through a graphic user interface of the communications device 16). In embodiments of these types the writing instrument 44 may include sensors and a wireless transmitter (e.g., Bluetooth) to couple information wirelessly (e.g., to the wireless transceiver component 40). Conventional or otherwise known technology, such as that incorporated into the Apple Pencil, can be included in embodiments of the writing instrument 44.

Operator interface 26 may be operated by a user of the auditory stylus 12 to select different operating mode functions or otherwise control the stylus (e.g., volume control). In embodiments, for example, operator interface 26 comprises one or more user-actuatable push buttons.

Interface/control component 20 controls the interactions of the components of the auditory stylus 12, enabling those components to provide the operating mode functions and to operate in accordance with the methods described herein (e.g., in combination with earpieces 14 and communication device 16. Certain components of the auditory stylus 12, such as for example interface/control component 20, memory 32, speech filter component 34, and/or transcription/translation component 38 are described as functional components that can be implemented by any conventional of otherwise known physical hardware, software and/or firmware components and configurations. For example, in embodiments the interface/control component 20 and memory 32 can comprise a microprocessor and/or digital signal processor coupled to random access memory (RAM), read only memory (ROM) and/or solid state drive memory (SSD). The interface/control component 20 and memory 32 can also be implemented by discrete circuit components and/or application specific integrated circuits (ASICs). The operating functionality and methods described herein may be provided by software stored in the memory 32 that is executed by the interface/control component 20. In embodiments, speech filter 34 may be implemented by one or more hardware components (e.g., including amplifiers and/or filters) and/or software (e.g., stored in memory 32) that is executed by the interface/control component 20. Similarly, the transcription/translation component 38 can be one or more separate components, including memory, that provide the transcription and/or translation functions described herein. Embodiments of transcription/translation component 38 may also include software (e.g., stored in memory 32) that is executed by the interface/control component 20. In yet other embodiments, functional components of the auditory stylus 12, such as for example the speech filter component 34 and/or transcription/translation component 38, can be provided by the communications device 16 (e.g., by apps or other software executed by the communications device). In yet other embodiments, functional components of the auditory stylus 12, such as for example the speech filter component 34 and/or transcription/translation component 38, can be provided by a third party on-demand cloud computing platform via the wireless transceiver component 40 and/or a wireless transceiver of the communication device 16. Other configurations for providing the functionality of the auditory stylus 12 are contemplated.

Communication device 16 comprises one or more devices operated by users in connection with auditory stylus 12 to enhance the perception of speech collected or received by the stylus. For example, communication device 16 may include commercially available mobile devices such as tablets, smart phones and laptop computers. Communication devices 16 may also include desktop computers.

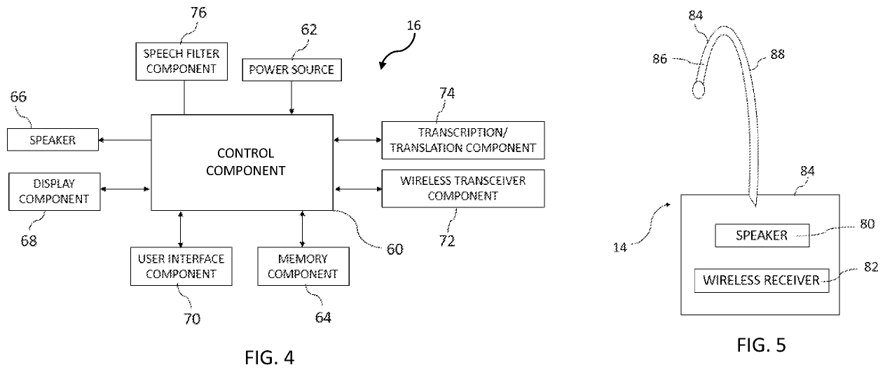

FIG. 4 is a diagrammatic illustration of components of a communication device 16 in accordance with embodiments. As shown, the communication devices may include a control component 60 coupled to a power source 62, memory 64, speaker 66, display component 68, user interface component 70, wireless transceiver component 72, transcription/translation component 74 (e.g., if not part of auditory stylus 12) and speech filter component 76 (e.g., if not part of the stylus). Wireless transceiver component 72 communicates with the wireless transceiver component 40 and/or the wireless transmitter 48 of the remote microphone 42 of auditory stylus 12 (e.g., by Bluetooth). Alternatively or in addition, the wireless transceiver component 72 may communicate with other computing resources (e.g., in the cloud via WiFi). Hardware, firmware and software configurations of the types described above in connection with auditory stylus 12 can be used to implement communication devices 16. For example, transcription/translation component 74 and speech filter component 76 can be provided by apps on the communication device 16. The display component 68 and user interface component 70 can be provided by a graphical user interface (GUI) on the communication device 16. Users can operate such a GUI through the use of the auditory stylus 12 and its writing instrument 44 in embodiments.

In embodiments, an auditory stylus app can be downloaded onto the communication device 16 and run to provide operating mode functions of the type described herein in connection with the auditory stylus 12. For example, the auditory stylus app may provide GUI functionality enabling users to operate the auditory stylus 12 in accordance with methods described herein.

FIG. 5 is a diagrammatic illustration of an earpiece 14. As shown, the earpiece 14 includes a speaker 80 and wireless receiver 82 that may be mounted to (e.g., and enclosed in) a housing 84. An ear hook 86 and sound distribution tube 88 are coupled to the housing 84. The ear hook 86 is part of the sound distribution tube 88 in embodiments. Electrical speech signals received by the wireless receiver 82 from the auditory stylus 12 (e.g., from the wireless transceiver component 40) and/or from the communication device 16 (e.g., from the transceiver component 72) are coupled to the speaker 80. Speaker 80 generates audible speech content from the speech signals, and the audible speech content may be directed to the ear canal of a user wearing the earpiece 14 through the tube 88. In embodiments, the earpiece 14 is configured to be mounted to a user's ear by the ear hook 86. Other embodiments include other configurations of ear hooks (e.g., separate from the sound distribution tube) to mount the earpiece to the user's ear. Alternatively or in addition, the earpiece 14 can include structures such as an earbud that support the earpiece directly in the user's ear. Other configurations for the earpiece 14 are contemplated. Embodiments of speech enhancement system 10 may include multiple earpieces 14 being used by multiple users (e.g., simultaneously as part of a group using the system). Earpiece 14 may be powered by a battery (not shown), such as for example a rechargeable battery.

Operational modes and features of speech enhancement system 10 include the following. These operating modes and features can be selected by the operator using the operator interface 26 of the auditory stylus 12 and/or the user interface component 70 of the communication device 16. During any or all of these operating modes the auditory stylus 12 can be positioned at a location optimized or expected to receive speech and other sound of interest. In embodiments, the remote microphone 50 can be detached from the auditory stylus 12 and positioned a location spaced apart from the auditory stylus that is optimized or expected to receive speech and other sound of interest.

Original Speech Mode. Speech received by one or more of the auditory stylus microphones 28 or 50 can be broadcast in real time (i.e., at the time of receipt) by one or more of the speaker 30 of the auditory stylus 12, speaker 66 of the communication device 16 or the earpieces 14 being worn by one or more users. The received original speech can also be stored in memory such as 32, and retrieved from the memory for later broadcast (i.e., in delayed time).

Filtered Speech Mode. The speech received by the one or more of the auditory stylus microphones 28 or 50 can be filtered (e.g., by the speech filter component 34) before being broadcast and/or stored (e.g., as in the original speech mode).

Transcription Mode. Speech received by one or more of the auditory stylus microphones 28 or 50 can be transcribed into text form (e.g., by the transcription/translation component 38) and displayed in text form (e.g., by the display component 68 of the communication device 16). The transcribed speech can also be stored in memory such as 32, and retrieved from the memory for later display (i.e., in delayed time).

Translation Mode. Speech received by one or more of the auditory stylus microphones 28 or 50 can be translated from one language to another (e.g., by the transcription/translation component 38). The translated speech can be broadcast in real time with or without filtering, and/or stored in memory for later broadcast (e.g., in manners substantially the same as or similar to the original speech or filtered speech by the Original Speech Mode or Filtered Speech Mode). Alternatively or in addition, the translated speech may be transcribed, broadcast and/or stored (e.g., in manners substantially the same as or similar to the speech of the Transcription Mode).

As evident from the above descriptions, one or more of the operating modes may be performed simultaneously or sequentially. For example, the transcription mode can be performed simultaneously with the filtered speech mode in embodiments. In embodiments, reading of the speech displayed in text form by the transcription mode can follow the user's real-time listening to the filtered speech during the filtered speech mode.

Speech enhancement system 10 enhances the ability of users to perceive speech. The system 10 is also convenient to use and operate. For example, a user can position the stylus 12 at a location optimized to pick up conversations or other sound expected to be of interest to the users (e.g., by the built-in microphone 28). The remote microphone 42 (alone or in addition to the stylus microphone 28) can similarly be positioned at a location optimized to pick up sounds expected to be of interest to users. When the remote microphone 42 is used in combination with the built-in microphone 28, the area or zone over which such sound expected to be of interest may be received can be increased, thereby increasing the area (of sound receipt and/or listener-users) of the speech enhancement. Broadcasting the speech (e.g., by speaker 30 of the auditory stylus 12, earpieces 14 and/or speaker 66 of the communication device 16 may enhance user's ability to perceive the speech (e.g., through increased volume). These audible speech enhancement capabilities can be further enhanced by filtering the speech before it is broadcast (e.g., by the speech filter component 34). Perception can be enhanced by the user's ability to read the speech in text form (e.g., while listening to the broadcast speech, or later).

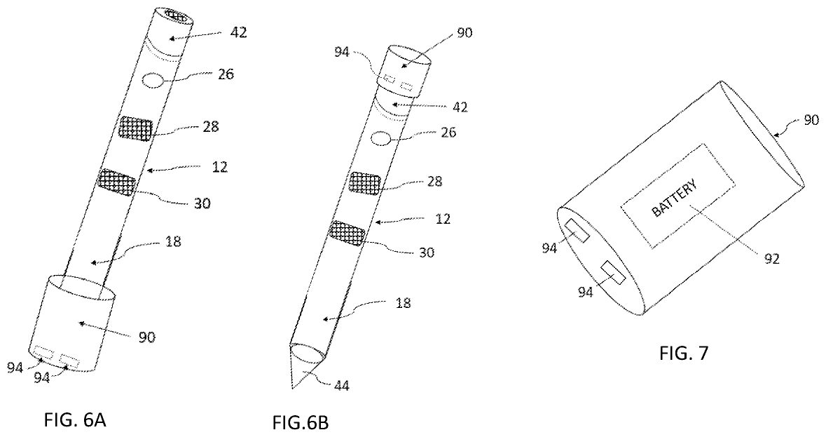

FIGS. 6A and 6B illustrate embodiments of the auditory stylus 12 comprising a cap 90 including a battery 92 that can function as the power source 22 for the stylus. FIG. 7 is a detailed diagrammatic illustration of embodiments of the cap 90. The battery 92 is configured for power transfer to components of the auditory stylus 12 (e.g., through the contacts 24), and in the illustrated embodiments includes contact pads 94 for the power transfer. During use of the auditory stylus 12, the cap 90 can be coupled to the stylus in a power transfer configuration. As shown in FIG. 6B, for example, in the power transfer configuration the cap 90 can be attached to the end of the auditory stylus 12 opposite the writing instrument 44, with the contact pads 94 coupled to the remote microphone 42 (e.g., to charge the battery of the remote microphone) and/or to the contacts 24 of the stylus (e.g., through connectors, not shown, in the remote microphone). In other embodiments the cap 90 is configured to be coupled to the end of the auditory stylus 12 in the power transfer configuration after the remote microphone 42 is removed from the stylus. Cap 90 and/or the auditory stylus 12 are configured in embodiments to enable the cap to be removably coupled to the housing 18 of the auditory stylus 12 in the power transfer configuration. The removable coupling functionality can, for example, be provided by snap structures on the cap 90 and/or the housing 18.

As shown in FIG. 6A, the cap 90 can be configured to be removably coupled to the end of the auditory stylus 12 including the writing instrument 44 in a storage configuration when the stylus is not in use. Cap 90 and/or the auditory stylus 12 are configured in embodiments to enable the cap to be removably coupled to the housing 18 of the auditory stylus 12 in the storage configuration. The removable coupling functionality can, for example, be provided by snap structures on the cap 90 and/or the housing 18.

In embodiments, the battery 92 can be a rechargeable battery, and the cap 90 configured for battery recharging when the cap is in the storage configuration. In the embodiments illustrated in FIG. 6A, for example, the contact pads 94 can be located for connection to a battery charger (not shown) when the cap is in the storage configuration.

Although described with reference to embodiments, those of skill in the art will recognize that changes can be made in form and detail without departing from the spirit and scope of the claims.

What is claimed is:

1. A handheld auditory stylus, comprising:
a housing configured to be held and moved by a user's hand;
an operator interface coupled to the housing;
a speaker coupled to the housing;
a first microphone coupled to the housing;
a memory component coupled to the housing;
a wireless transceiver;
a speech filter component coupled to the housing and configured to enhance speech intelligibility; and
an interface/control component coupled to the housing, operator interface, speaker, first microphone, wireless transceiver, memory and speech filter, the interface/control component configured to:
cause speech received by the first microphone to be filtered by the speech filter component;
cause the filtered speech to be stored in the memory;
cause the filtered speech to be broadcast by the speaker; and
cause the filtered speech to be transmitted by the wireless transceiver.

2. The handheld auditory stylus of claim 1 wherein:
the stylus further comprises a remote microphone including a wireless transmitter configured to be removably attached to the housing; and
the interface/control component is configured to cause speech received from the remote microphone via the wireless transceiver to be filtered by the speech filter component.

3. The handheld auditory stylus of claim 1 wherein:
the stylus further includes a transcription component coupled to the housing and the interface/control component; and
the interface/component is configured to:
cause the speech received from the first microphone to be transcribed by the transcription component;
cause the transcribed speech to be stored in the memory; and
cause the transcribed speech to be transmitted by the wireless transceiver.

4. The handheld auditory stylus of claim 1 wherein:
the stylus further includes a translation component coupled to the housing and the interface/control component; and
the interface/component is configured to:
cause the speech received from the first microphone to be translated;
cause the translated speech to be stored in the memory;
cause the translated speech to be broadcast by the speaker; and
cause the translated speech to be transmitted by the wireless transceiver.

5. The handheld auditory stylus of claim 1 wherein the operator interface is operable to control operation of the stylus, including to select one or more operating modes.

6. The handheld auditory stylus of claim 1 and further comprising a communication device, wherein the communication device includes:
a user interface;
a display;
memory;
a wireless receiver;
a speaker; and
a control component coupled to the user interface, display, memory, wireless receiver and speaker and configured to:
cause the speech received from the auditory stylus to be stored in the memory;
cause the speech received from the auditory stylus to be broadcast by the speaker; and
cause the speech received from the auditory stylus to be displayed in text form by the display.

7. The handheld auditory stylus and communication device of claim 6 wherein:
the communication device further includes a transcription component coupled to the control component; and
the control component is configured to:
cause the speech received from handheld auditory stylus to be transcribed;
cause the transcribed speech to be stored in the memory;
cause the transcribed speech to be displayed in text form by the display; and
cause the transcribed speech to be broadcast.

8. The handheld auditory stylus and communication device of claim 7 wherein:
the communication device further includes a translation component coupled to the control component; and
the control component is configured to:
cause the speech received from handheld auditory stylus to be translated;
cause the translated speech to be stored in the memory;
cause the translated speech to be displayed in text form by the display; and
cause the translated speech to be broadcast.

9. The handheld auditory stylus and communication device of claim 7 wherein the user interface of the communication device is operable to control operation of the communication device, including to select one or more operating modes.

10. The handheld auditory stylus and communication device of claim 6 and further including one or more earpiece, wherein each earpiece comprises:
an ear mount configured to support the earpiece on a user's ear;
a wireless receiver; and
a speaker coupled to the receiver to broadcast the received speech.

11. The handheld auditory stylus of claim 1 and further including one or more earpiece, wherein each earpiece comprises:
an ear mount configured to support the earpiece on a user's ear;
a wireless receiver; and
a speaker coupled to the receiver to broadcast the received speech.

12. The handheld auditory stylus of claim 1 wherein the stylus further comprises a writing instrument.

13. The handheld auditory stylus of claim 12 wherein the housing of the stylus comprises an elongated structure including a hand-engaging portion having a generally circular cross section.

14. The handheld auditory stylus of claim 13 and further including a cap configured to be removably coupled to the stylus.

15. The handheld auditory stylus of claim 14 wherein the cap includes a battery and is configured for coupling to the auditory stylus in a power transfer configuration.

16. The handheld auditory stylus of claim 15 wherein the cap includes a rechargeable battery and is configured for coupling to the auditory stylus in a storage configuration at which the rechargeable battery can be connected to a battery charger.

17. The handheld auditory stylus of claim 16 wherein the cap is configured to be removably coupled to an end of the auditory stylus including the writing instrument when in the storage configuration.

18. The handheld auditory stylus of claim 17 wherein the cap is configured to be removably coupled to an end of the auditory stylus opposite the end with the writing instrument when in the power transfer configuration.

19. A handheld auditory stylus, comprising:
a housing configured to be held and moved by a user's hand;
an operator interface coupled to the housing, wherein the operator interface is configured for selecting an operating mode;
a built-in speaker coupled to the housing;
a built-in microphone coupled to the housing;
a remote microphone including a wireless transmitter configured to be removably attached to the housing;
a wireless transceiver coupled to the housing and configured to wirelessly receive speech from the remote microphone;
a memory component coupled to the housing;
a speech filter component coupled to the housing and configured to enhance speech intelligibility; and
an interface/control component coupled to the housing, operator interface, built-in speaker, built-in microphone, wireless transceiver, memory and speech filter, the interface/control component configured to:
cause speech received by the built-in microphone and from the remote microphone via the wireless transceiver to be filtered by the speech filter component;
cause the filtered speech to be stored in the memory;
cause the filtered speech to be broadcast by the built-in speaker; and
cause the filtered speech to be transmitted by the wireless transceiver.

20. The handheld auditory stylus of claim 19 wherein:
the stylus further includes a transcription component coupled to the housing and the interface/control component; and
the interface/component is configured to:
cause the speech received from the built-in microphone and/or from the remote microphone to be transcribed by the transcription component;
cause the transcribed speech to be stored in the memory; and
cause the transcribed speech to be transmitted by the wireless transceiver.

21. The handheld auditory stylus of claim 20 wherein:
the stylus further includes a translation component coupled to the housing and the interface/control component; and
the interface/component is configured to:
cause the speech received from the built-in microphone and/or from the remote microphone to be translated;
cause the translated speech to be stored in the memory;
cause the translated speech to be broadcast by the built-in speaker; and
cause the translated speech to be transmitted by the wireless transceiver.
